(19) United States
(12) Patent Application Publication
(10) Pub. No.: US 2019/0253788 A1
(43) Pub. Date: Aug. 15, 2019

(54) BUMPOUT MOTORIZED EXPANSION SYSTEM

(71) Applicant: Zachary PIERCE, West Chester, PA (US)

(72) Inventor: Zachary PIERCE, West Chester, PA (US)

(21) Appl. No.: 16/343,268

(22) PCT Filed: Oct. 19, 2017
(86) PCT No.: PCT/US17/57456

§ 371 Date: Apr. 18, 2019

Related U.S. Application Data
(60) Provisional application No. 62/410,027, filed on Oct. 19, 2016.

(51) Int. Cl. H04R 1/28; H04R 1/02

(52) U.S. Cl. CPC H04R 1/2803; H04R 1/025; H04R 1/021

(57) ABSTRACT

A mobile speaker device having an extendable casing to generate an increased sound chamber with the push of a button particularly by utilizing a motor connected to a worm gear to engage with a centralized worm screw or other lifting screw or mechanism to expand the sound chamber to increase the volume of the sound chamber of the speaker.

### CROSS REFERENCE TO RELATED APPLICATIONS

The present application claims priority to U.S. Provisional Patent Application No. 62/410,027 filed Oct. 19, 2016, which is incorporated herein by reference in its entirety.

### FIELD OF INVENTION

The present invention is generally related to mobile speakers and modifiable speaker components.

### BACKGROUND OF INVENTION

There are several mobile or portable speakers that are currently in the marketplace. These device often connect with a Bluetooth connectivity module, or with a wire and provide the ability to amplify sounds from a music playing device through these speakers.

These speakers frequently suffer from poor acoustics due to their design, or are otherwise large and bulky, in an effort to create sufficient size and shape of the speakers to generate richer tones and increased bass.

### SUMMARY OF INVENTION

In the broadest sense, the invention is directed towards a speaker, comprising a movable chassis, slidingly engaged to a frame, wherein said movable chassis extends away from the frame to generate a larger volume sound chamber with the push of a button. The speaker device particularly utilizes a motor connected to a worm gear to engage with a centralized worm screw or other lifting screw or mechanism to expand the sound chamber to increase the volume of the sound chamber of the speaker housing. In preferred embodiments, the speaker comprises a frame comprising guides positioned around the interior edge of the exterior of the frame, wherein a mobile chassis is engaged to and travels up and down upon the guides on the frame.

A preferred embodiment is directed to an expandable speaker comprising a base, a frame, a mobile chassis nested within said frame, a motor, a worm, a worm gear, a lead screw, a cavity, a recess, and a driver, said mobile chassis having an inner side and an outer side, a top, and a bottom, and said frame having an inner and outer side, said outer side of mobile chassis nested within the outer side of the frame; said lead screw engaged to said worm gear, with said worm gear engaged to said worm, and said worm being engaged to said motor, with said lead screw having a top face in contact with the bottom of the mobile chassis; wherein rotation of the worm rotates the lead screw thus extending it and the mobile chassis, and increases the volume of the cavity of the speaker system.

In a preferred embodiment, the expandable speaker comprises an opening in the base for receiving a coin.

In a preferred embodiment, the expandable speaker comprises a clamp adjacent to the opening in the base, said clamp configured to receive said coin. In a further embodiment, said coin comprises a groove, said groove engaging to said clamp.

In a preferred embodiment, the expandable speaker comprising a clamp adjacent to the opening in the base, wherein said clamp is normally biased into a closed position, such that a coin within said clamp would be maintained. In a preferred embodiment, said expandable speaker comprises a clamp button, suitable to bias the clamp to an open position. In certain preferred embodiments, said clamp is disposed of such that a portion of the clamp extends into the opening.

In a preferred embodiment, the expandable speaker further comprises a wireless connection module. Preferably, said expandable speaker further comprises a processor, memory, storage, and a battery, capable of wirelessly connecting to a device and receiving data wirelessly and transmitting said data as sound waves.

In a preferred embodiment, the expandable speaker further comprises at least one track in the frame and at least one guide rail in the mobile chassis, said at least one track and at least one guide rail being configured to engage to one another. In certain preferred embodiments, the guide rail slides in the at least one track as the mobile chassis extends.

An expandable speaker comprising a base having an opening, a frame, a mobile chassis nested within said frame, a motor, a worm, a worm gear, a lead screw, a cavity, a recess, a clamp, and a driver, said mobile chassis having an inner side and an outer side, a top, and a bottom, and said frame having an inner and outer side, said outer side of mobile chassis nested within the outer side of the frame; said lead screw engaged to said worm gear, with said worm gear engaged to said worm, and said worm being engaged to said motor, with said lead screw having a top face in contact with the bottom of the mobile chassis; wherein rotation of the worm rotates the lead screw thus extending it and the mobile chassis, and increases the volume of the cavity of the speaker system; said clamp disposed of within said opening biased in a closed position, capable of being biased open to accept a coin, said coin capable of selective attachment to a surface.

An expandable speaker comprising a base having an opening, a frame, a mobile chassis nested within said frame, a motor, a worm, a worm gear, a lead screw, a cavity, a recess, a clamp, and a driver, said mobile chassis having an inner side and an outer side, a top, and a bottom, and said frame having an inner and outer side, said outer side of mobile chassis nested within the outer side of the frame; said lead screw engaged to said worm gear, with said worm gear engaged to said worm, and said worm being engaged to said motor, with said lead screw having a top face in contact with the bottom of the mobile chassis; wherein rotation of the worm rotates the lead screw thus extending it and the mobile chassis, and increases the volume of the cavity of the speaker system; said clamp disposed of within said opening biased in a closed position, capable of being biased open to accept a coin, said coin capable of selective attachment to a surface; and wherein the frame comprises at least one track and the mobile chassis comprises at least one guide rail, said at least one track and at least one guide rail being configured to slideably engage to one another.

An expandable speaker system comprising a base, a motor, a frame, and a mobile chassis, wherein the mobile chassis extends away from the base to increase the volume of the sound chamber.

An expandable speaker system comprising a base, a motor, a frame and at least two mobile chassis, wherein the at least two mobile chassis are nested together and each extends away from the base to increase the volume of the sound chamber.

The expandable speaker system of claim 1 or 2 further comprising an attachment mechanism on the base of a speaker.

A method of expanding the volume of a speaker comprising: Providing an expandable speaker comprising a base having an opening, a frame, a mobile chassis nested within said frame, a motor, a worm, a worm gear, a lead screw, a cavity, a recess, a clamp, and a driver, said mobile chassis having an inner side and an outer side, a top, and a bottom, and said frame having an inner and outer side, said outer side of mobile chassis nested within the outer side of the frame; said lead screw engaged to said worm gear, with said worm gear engaged to said worm, and said worm being engaged to said motor, with said lead screw having a top face in contact with the bottom of the mobile chassis; engaging the motor to rotate, wherein rotation of the motor rotates the worm, rotating the lead screw with the rotation of the worm; and extending the lead screw and the mobile chassis, wherein said extending of the lead screw and the mobile chassis increases the volume of the cavity of the speaker system.

An extendable speaker device having a chamber volume, and having a first position and a second position, said first position having a smaller chamber volume than said second position, said speaker device comprising: a base having an opening, a frame, a mobile chassis nested within said frame, a motor, a worm, a worm gear, a lead screw, a cavity, a recess, a clamp, and a driver, said mobile chassis having an inner side and an outer side, a top, and a bottom, and said frame having an inner and outer side, said outer side of mobile chassis nested within the outer side of the frame; said lead screw engaged to said worm gear, with said worm gear engaged to said worm, and said worm being engaged to said motor, with said lead screw having a top face in contact with the bottom of the mobile chassis; wherein rotation of the worm rotates the lead screw thus extending it and the mobile chassis, and increases the volume of the cavity of the speaker system; said clamp disposed of within said opening biased in a closed position, capable of being biased open to accept a coin, said coin capable of selective attachment to a surface.

### BRIEF DESCRIPTION OF THE DRAWINGS

FIG. 1 depicts an exploded view of an expandable speaker.

FIG. 2 depicts a top perspective view of the expandable speaker in a closed position.

FIG. 3 depicts a detail of the bottom face of the expandable speaker.

FIG. 4 depicts an expandable speaker in the expanded position

FIG. 5 depicts a harmonic chart of an optimized speaker, in a first position and then in an extended position.

### DETAILED DESCRIPTION OF THE EMBODIMENTS

Component list:
1. Top Cover
2. Inner Top Cover (frame)
3. Inner Cover (mobile chassis)
4. Driver
5, Passive Radiator
6. Inner Cover Bottom
7. Gear Support
8. Battery and electronic components
9. PCB
10. Worm
11. Gear
12. Motor
13. Clamp button
14. Attaching Clamp
15. Lead Screw
16. Expansion button
17. USB Cover
18. Inner Bottom Cover
19. Indicator (LED)
20. Connection Coin.
21. Gear manifold
22. Screw Recess
23. Coin opening
24. Bottom Cover
25. Tracks
26. Guide Rail
27. Coin Groove
28. Clamp Teeth
29. Grill

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosed embodiments. The upper and lower limits of these smaller ranges may independently be included in the smaller ranges, and are also encompassed within the invention, subject to any specifically excluded limit in the stated range. Where the Mated includes one or both of the limits, ranges excluding either or both of those included limits are also included in the invention.

Unless defined otherwise, all technical and scientific terms used herein have the same meaning as commonly understood by one of ordinary skill in the art of the disclosure. All publications mentioned herein are incorporated herein by reference to disclose and describe the methods and/or materials in connection with which the publications are cited.

It must be noted that as used herein and in the appended claims, the singular forms “a,” “an,” and “the” include plural referents unless the context clearly dictates otherwise. It is noted that the claims may be drafted to exclude any optional element. As such, this statement is intended to serve as antecedent basis for use of such exclusive terminology as “solely,” “only” and the like in connection with the recitation of claim elements, or use of a “negative” limitation.

The publications discussed herein are provided solely for their disclosure prior to the filing date of the present application. Nothing herein is to be construed as an admission that the presently-claimed subject matter is not entitled to antedate such publication by virtue of prior invention. Further, the dates of publication provided may be different from the actual publication dates which may need to be independently confirmed.

The speaker devices (also referred to as expandable or extendable speaker devices) described and depicted herein utilize the fact that a larger volume chamber can increase the dB of certain ranges of sound in the ranges detectable by human ears. Particularly, this includes those in the range of 20-20 k Hz, and specifically, in the range of between 100-500 Hz. A key issue in small and portable speakers is that they suffer from low capacity in certain ranges. This leaves listeners wanting for more, as such small speakers often lack bass, with an overbearance of mid and high range sounds, i.e. those typically above the 4^{th} and 5^{th} octaves. We expect that a first octave is between 16 and 32 Hz, with the 2^{nd} to 5^{th} octaves between 32 and 512. We expect, that most sounds, specifically those of music, fail within the 88 keys of a standard piano, and thus often fall below C8, or at about 4186 Hz. Such small speaker chambers often maximize the sounds between about 512 and 4186 Hz, but lack support of the 16-512 ranges that often give life and vigor to music, through the base line.

The speaker described herein, maintains a small stature, as well as small components that can be used with an internal battery, but that has an expandable feature to allow for an inner portion of the speaker to move up and down to increase the sound chamber, and increase the dB level within the low range of 16-512 Hz through expansion of this chamber. Yet, this allows the speaker to maintain a small footprint and use small and lightweight components to provide a mobile powered speaker.

The basic audio system for the speaker employs an active acoustic driver and a passive radiator in a single sealed cabinet; this is a type of commonly employed acoustic reflex audio alignment. This type of system is efficient and can provide for greater bass (low frequency) performance but is highly dependent on the air volume of the enclosure for the active and passive elements. The speaker design is based on two acoustic volumes, one when the system is closed and one when the system is expanded. When the system is closed, the air volume in the cabinet (behind the drive units) be a minimum. When the air volume is at the minimum, the active driver will have a stiffer suspension and will resonate at a higher frequency, this will in turn cause the passive element to produce minimum output; the net result is the system will be unable to produce as much low frequency output. When the system is expanded, the air volume in the cabinet (behind the drive units) will be a maximum. When the air volume is at the maximum, the active driver will have a softer suspension and will resonate at a lower frequency, this will in turn cause the passive element to produce increased output at low frequencies; the net result is the system will produce more low frequency output and will appear to play louder overall with more bass.

The device is unique in that it provides a motorized expansion system for audio products. This gives a user the ability to expand the small volume to modify and enhance the audio quality of the speaker device.

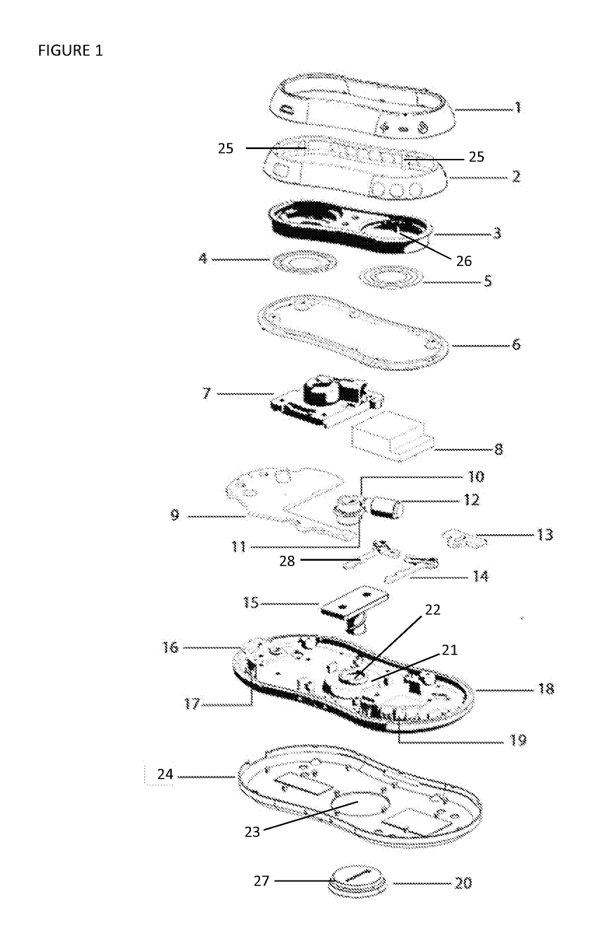

In preferred embodiments, as depicted in FIG. 1, the mobile speaker comprises a top cover 1, which is a skin that extends over and around the inner top cover (frame) 2. Beneath that inner top cover 2 is an inner cover (mobile chassis) 3. The inner cover 3 has two openings extending through the inner cover 3, with the openings generally a circular shape having a diameter for receiving a driver 4 in one of the openings, and a passive radiator in the second opening.

An inner cover bottom 6, contacts a bottom face of the inner top cover 2, and then contacts with the inner bottom cover 18. Several components fit within the chamber created between the inner bottom cover 18 and the inner top cover 2. The gear support 7 is affixed adjacent to the PCB 9, and a battery (and electronic components) 8, adjacent thereto on another side. The gear support 7 then secures to a gear manifold 21, which comprises a screw recess 22. The lead screw 15 comprises a screw feature on the bottom and a plate on the top. The plate of the lead screw 15 contact with the inner cover 3, and is attached together to allow the inner cover 3 to move up and down with movement of the lead screw 15.

The lead screw 15 is driven by the worm mechanism, comprising a worm 10, a gear 11, and a motor 12. Those of skill in the art will recognize the appropriate gear ratios to employ to allow for a brief activation of the motor to raise the lead screw 15 and then to return it again to its closed position.

The inner bottom cover 18 comprises a USB Cover 17, wherein a USB port, as shown as the trapezoidal space on the top cover 1, is attached to the PCB 9. Further, the PCB 9 contains at least one button attached thereto, which is in contact with the Expansion button 16. The Expansion button 16 functions as the activation switch, to allow for the motor 12 to be engaged, to expand or compress the inner cover 3 between its two positions. An indicator 19 is provided, comprising a power button, as well as buttons to increase and decrease volume. The top cover 1 indicates a plus sign for an increase in volume, a minus sign for decrease in volume and the power symbol to the right of the minus sign. Openings in the inner top cover 2, allow for buttons on the indicator 19 to transmit signals to the electronics components tied into the PCB (printed circuit board). The indicator 19 further comprises one or more light sources, typically an LED light, or other similar light emitting component, which can indicate one or more functions. A single light may simply indicate power on or power off. Additional lights, or different colors may indicate different modes of the device, or also illuminate under the plus and minus signs to allow for easy identification of the volume buttons.

The bottom cover 24 fits over and around the inner bottom cover 18, and clearly defined in the middle is a coin opening 23 provides access to the pair of attaching claims 14. This feature allows for access to a clamping mechanism to secure the speaker system to a coin 20. The coin 20, provides for a coin groove 27. When the coin is pressed into the coin opening 23, the attaching clamps 14, secure into the coin groove 27 and attach the speaker system to the coin 20. The clamp button 13 releases the spring loaded clamps, pulling away the clamp teeth 28, and allow the coin to release. This clamp functions by being normally biased in a compressed or closed position, such that a coin 20, being inserted into the coin opening 23, would engage with the clamps 14, to secure the coin 20 to the clamp. The clamp is released, away from its resting/normally biased position by pressing of the clamp button 13, which opens the clamp to allow for release of the coin 20. Release of the clamp button 13 returns the clamp to its normally biased, and closed position.

When the speaker is powered on, and in a compressed state, the volume of the speaker chamber will be at its minimum. By activating the expansion button 17, the motor 12 will activate and drive the worm 10 to rotate the gear 11 to rotate the lead screw 15, thereby extending the inner cover 3. The inner cover 3 contains an outer edge having at least one guide rail 26, and the guide raise 26 correspond to tracks 25 within the inner top cover 2.

The battery/electrical component 8 feature includes both the battery and certain of electrical components, which are affixed to the PCB, including a Bluetooth, or connectivity module, as well as a small processor, memory, and storage, allowing both storage of the necessary programs to run the speaker device, including the simple actions of turning on and off the power, turning up and down the volume, and extending and compressing the lead screw 15 (activating the motor 12) to extend and compress the expandable speaker. The precise size and location of these features can be modified and affixed to different components of the PCB, and the size and capacity of the battery can be modified to increase capacity with increased size. The driver setup may further comprise a magnet, basket, spider, surround, and cone, as is known to those of ordinary skill in the art, and thus is not specifically depicted. These components can be purchased together, sized appropriately for the speaker housing as described herein, and connected to the PCB to power and play music through these features.

Further, the device is secured together with threaded fasteners, rivets, adhesives, and other fastening devices can be utilized to create a secure and professional finish. Those of skill in the art recognize the simplicity in securing such components and thus they are excluded from view.

In a preferred embodiment, the power button connects power from battery 8 to the PCB 9 to provide power to the electrical components. After power is on, expansion button 16 can then be depressed which elevates the inner cover 3, and thus enlarging the speaker chamber volume. The action of pressing the expansion button 16, through the PCB 9 board tells the motor 12 to spin in order to drive the worm 10. The motor runs in this direction for between about 0.1 to about 2 seconds, and then stops. In preferred embodiments, the motor runs for about 0.3 to about 1.0 seconds.

A second depression of the expansion button 16 triggers the PCB 9 to reverse the motor 12 and lower the inner cover 3. To keep the inner cover 3 moving along a proper axis, the tracks 25 in the inner top cover 2 align with the guide rails on the inner cover 3.

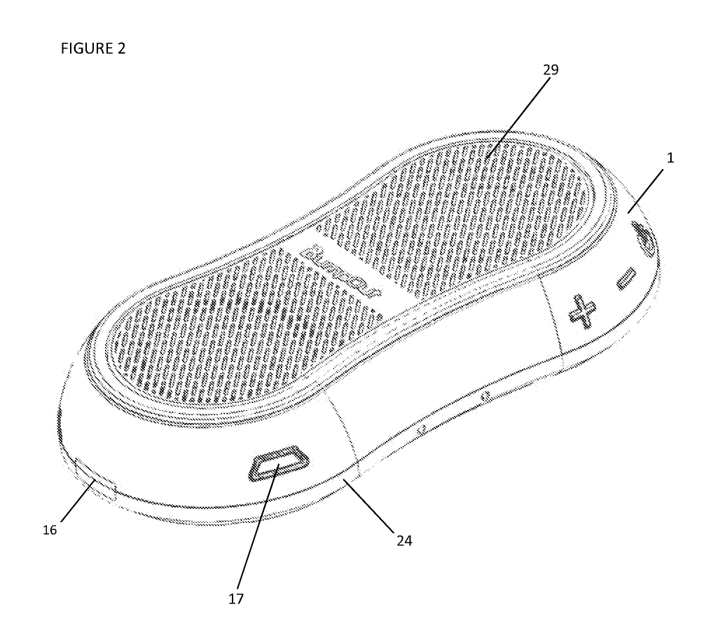

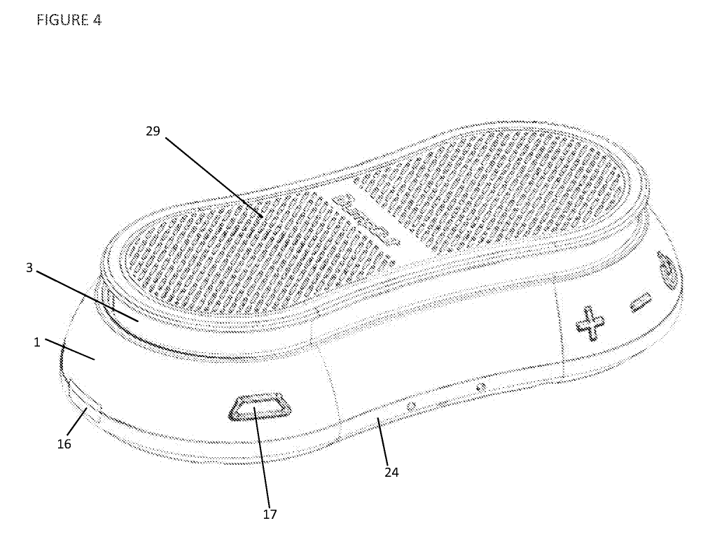

FIG. 2 depicts a top perspective view of the speaker in a closed or minimum volume position. As shown, the grill 29 is positioned flat against the top cover 1. By contrast, FIG. 4 depicts the speaker in an expanded view, with the grill 29, above the top cover 1. The vertical expansion or extension of the speaker, and the corresponding additional volume is limited by the height of the inner cover 3, which is shown extending past the top cover 1.

However, certain embodiments may utilize a nested or accordion like structure that enables the inner cover (moving chassis) to expand significantly beyond the depth of the speaker. For example, a 1″ deep speaker when compressed may have a 0.75″ moving chassis. However, by nesting the inner cover with a second inner cover, the extension may provide for slightly less than double the normal depth of the inner cover, double. Additional nested moving chassis can then be used to further extend the inner cover, and increase volume of the speaker. There are diminishing returns, as further nested components may be structurally weak, take up too much space, increase weight, or be impractical for engineering the worm to drive a nested worm or screw to make such extension. In such cases, a hydraulic, or angled screw may be necessary to allow for greater travel. The sides of the inner cover may further utilize an accordion like material, and thus the sound chamber may be extended beyond the depth of the inner chamber 3. This may thus allow for an increase in the volume of the speaker to be greater than double the volume of the speaker when in a compressed state.

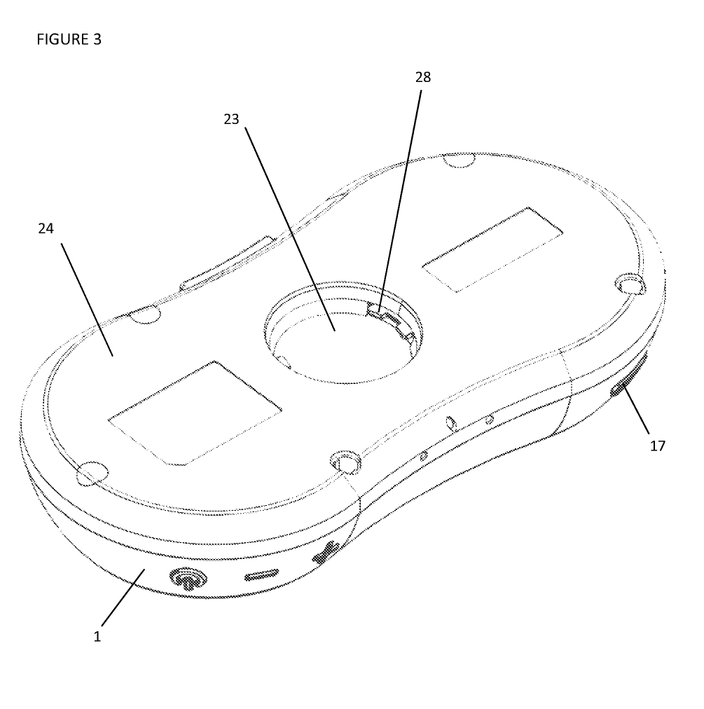

FIG. 3 depicts the speaker from a bottom view, showing the coin opening 23, and the clamp teeth 28 of the clamp 14. The coin 20 engages into this opening, and to the clamp 14, to secure the speaker to the coin 20. The coin, can be attached to a surface, thus allowing selective attachment of the speaker to the coin for use. For example, placing the coin in the bathroom, to listen to music in the shower or bath. Attaching a coin to a bicycle to then attach the speaker and enjoy the ride.

Several speakers can be electronically connected to a single device, via Bluetooth or other wireless connectivity. This allows for multiple speakers to play the same music simultaneously. Thus, in a larger room, two or more speakers can be jointly connected to a single device, and create better sound projection in the room. Another example would be use of the devices as a home theater accessory, and add several speakers to the front, side, or rear of the room to give surround sound like feel to a room.

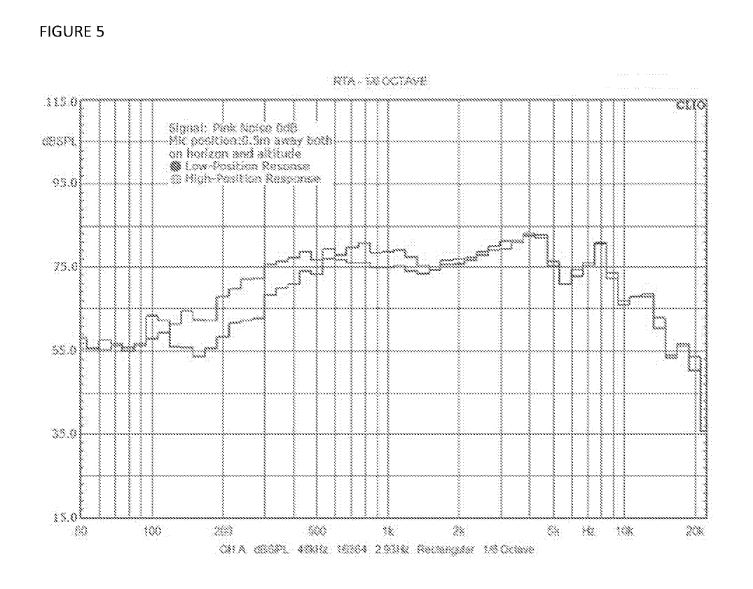

FIG. 5 provides a graphical representation of acoustical performance in a first, compressed position, and a second, extended position. The audio system of FIG. 5 consists of a 40 mm audio transducer (driver) and a 38 mm passive radiator in an acoustic chamber with a volume that can be modified from a first position to a second, position having a larger volume. The acoustical volume at a first position (compressed) is approximately 0.0322 L. However, by depressing the extension button 16, the motor 12 engages the worm 10 to drive the lead screw 15 to expand the acoustical chamber. Expansion nearly doubles the volume to 0.0617 L. This change in volume of more than 90% results in an activation of the passive radiator and more space for the acoustical resonance of the driver. Effectively, the increased space is a softer spring behind the driver cone, allowing it to travel further and allowing the passive radiator to travel further. The net result is an increase in acoustical output below 500 Hz of between about 4 and 10 dB. As sound is logarithmic, a sound of 10 dB is twice as loud. This increase is important as increased sound from a small structure, allows for lower power consumption as well as better performance from the device. By contrast, there is a small increase in the 500 Hz to about 1500 Hz range for the lower volume.

This is important, however, as the low frequencies lag behind in dB rating, and thus music feels flat, with reduced output of these low frequencies. This increase provides a significant increase in the low frequency sounds to provide a well-rounded speaker in a small structural device.

The configuration as tested in FIG. 5 was a result of several tests of components, both in size of the audio transducer and passive radiator, as well as the volume of the chamber at the closed position and the extended position. The volume of the chamber was tested at, at least one smaller size at the compressed size, and at least one larger size at the expanded volume size. Using the 40 mm audio transducer (driver) and a 38 mm passive radiator, we determined that a volume of about 0.03 L at a minimum and about 0.07 L at an extended maximum provided for an optimum listening profile. This provided optimal sound quality, distortion, and sound pressure level, based on the size of the components and volume. Furthermore, the sizes provide for an efficient power consumption, providing that the small included battery can power the device for several hours before needing to be recharged. Recharging can be simply performed by securing into the attached USB port and then to a power source. Indeed, for continual playing, the power source can be directly connected. Updates of firmware, software, and other electronic means can be performed through the USB port or wirelessly through the wireless connection.

However, when size and power consumption are immaterial, such as in the home theater, concert space, or larger uses, this concept can be then expanded into much larger systems. For example, this same concept can be used in in-wall speaker systems, wherein the speaker is flush with a wall, but is then expanded for use to create an enhanced audio profile. Other free standing speakers can also use this same technology to create a speaker that has a slim profile in certain embodiments, but a larger profile when necessary. This provides for larger speakers that are free standing and can expand using the technology described herein. Accordingly, such expandable devices may be utilized wherever speaker systems are utilized.

The expansion means of the preferred embodiments utilizes a simple worm gear, driving a lifting screw. The worm gear travels in one direction to raise or extend the screw, and travels in the other direction to lower the screw. In the speaker device herein, by extending the screw, the inner cover, and grill are extended, thus increasing the volume of the speaker. The simplicity of the worm gear mechanism provides for a reliable and consistent movement of the speaker components into the small and larger volume options. Those of skill in the art will recognize that suitable lifting mechanisms may be exchanged for the worm gear mechanism, including a spring loaded expansion system, having a spring normally biased to expand to the larger volume, and being compressible and latched in a smaller volume position. Hydraulic systems can easily expand or compress with air or fluids, and those of skill in the art will recognize other suitable systems and mechanisms to cause such extension. The result is that the device allows the movable chassis to expand up and down to increase the sound chamber volume in the speaker system.

Earphones or headsets are also speaker systems. Accordingly, the embodiments herein can be utilized in very small speakers to expand the sound chamber of such headsets and earphones. For example, ear buds, typically placed within the ear canal, can expand to increase the volume of the driver space. Similarly headsets can also be expanded, as provided in the description herein.

Further types of speaker systems include outdoor fully water proof/sand proof speakers that expand. Outdoor garden or yard speakers that expand and plug in, indoor speakers that expand. Speaker systems can be utilized in a vehicle, can plug into your car (tailgating) that can expand just as the wall mounted speakers and other versions as described herein.

Indeed, concert speakers that are compressed for shipping then expand at a venue may provide for greater efficiency in moving and transporting speakers for mobile setups. This provides an opportunity to greatly reduce the space necessary for some of the largest speakers. This is particularly suitable to use a nesting strategy for the mobile chassis, such that one, two, three, or more chassis can be nested together, and expand to increase the acoustic volume as necessary for the particular speaker system. By nesting the chassis together, the ends can be attached with a flexible material to seal off the chamber, or the shape and design can be situated wherein the nested shape engages the top of a chassis to the bottom of the next to seal off the sound chamber.

In this manner, each of the nested chassis would contain a corresponding set of tracks and guide rails to ensure that each of the next in line chassis would move vertically as necessary to expand the sound chamber.

Alternatively, an accordion like material can be disposed of around the edge of a first layer, and to the edge of a second layer, which is movable. This second layer can then be extended away from the first layer, with the accordion like material defining the boundary of the increasing chamber. In such a scenario, the accordion like material can allow for expansion of the chamber of more than just the width of the first layer.

The invention now being fully described, those of skill in the art will recognize that suitable modifications may be made to the invention without losing the spirit of the invention.

What is claimed is:

1. An expandable speaker comprising a base, a frame, a mobile chassis nested within said frame, a motor, a worm, a worm gear, a lead screw, a cavity, a recess, and a driver, said mobile chassis having an inner side and an outer side, a top, and a bottom, and said frame having an inner and outer side, said outer side of mobile chassis nested within the outer side of the frame; said lead screw engaged to said worm gear, with said worm gear engaged to said worm, and said worm being engaged to said motor, with said lead screw having a top face in contact with the bottom of the mobile chassis; wherein rotation of the worm rotates the lead screw thus extending it and the mobile chassis, and increases the volume of the cavity of the speaker system.

2. The expandable speaker of claim 1 comprising an opening in the base for receiving a coin.

3. The expandable speaker of claim 2 comprising a clamp adjacent to the opening in the base, said clamp configured to receive said coin.

4. The expandable speaker of claim 3 wherein said coin comprises a groove, said groove engaging to said clamp.

5. The expandable speaker of claim 3 wherein said clamp is normally biased into a closed position, such that a coin within said clamp would be maintained.

6. The expandable speaker of claim 5, further comprising a clamp button, suitable to bias the clamp to an open position.

7. The expandable speaker of claim 3, wherein said clamp is disposed of such that a portion of the clamp extends into the opening when said clamp is in a closed position.

8. The expandable speaker of claim 1, further comprising a wireless connection module.

9. The expandable speaker of claim 8, further comprising a processor, memory, storage, and a battery, capable of wirelessly connecting to a device and receiving data wirelessly and transmitting said data as sound waves.

10. The expandable speaker of claim 1 wherein the frame comprises at least one track and the mobile chassis comprises at least one guide rail, said at least one track and at least one guide rail being configured to engage to one another.

11. The expandable speaker of claim 10, wherein the guide rail slides in the at least one track as the mobile chassis extends.

12. An expandable speaker comprising a base having an opening, a frame, a mobile chassis nested within said frame, a motor, a worm, a worm gear, a lead screw, a cavity, a recess, a clamp, and a driver, said mobile chassis having an inner side and an outer side, a top, and a bottom, and said frame having an inner and outer side, said outer side of mobile chassis nested within the outer side of the frame; said lead screw engaged to said worm gear, with said worm gear engaged to said worm, and said worm being engaged to said motor, with said lead screw having a top face in contact with the bottom of the mobile chassis; wherein rotation of the worm rotates the lead screw thus extending it and the mobile chassis, and increases the volume of the cavity of the speaker system; said clamp disposed of within said opening biased in a closed position, capable of being biased open to accept a coin, said coin capable of selective attachment to a surface.

13. The expandable speaker of claim 12 wherein said coin comprises a groove, said groove engaging to said clamp, and further comprising a clamp button suitable to bias the clamp into an open position.

14. (canceled)

15. The expandable speaker of claim 12, wherein said clamp is disposed of such that a portion of the clamp extends into the opening, when said claim is in a closed position.

16. The expandable speaker of claim 12, further comprising a wireless connection module.

17. The expandable speaker of claim 12 wherein the frame comprises at least one track and the mobile chassis comprises at least one guide rail, said at least one track and at least one guide rail being configured to engage to one another.

18. The expandable speaker of claim 17, wherein the guide rail slides in the at least one track as the mobile chassis extends.

19. (canceled)

20. (canceled)

21. The expandable speaker system of claim 1 further comprising an attachment mechanism on the base of a speaker.

22. A method of expanding the volume of a speaker comprising:
Providing an expandable speaker comprising a base having an opening, a frame, a mobile chassis nested within said frame, a motor, a worm, a worm gear, a lead screw, a cavity, a recess, a clamp, and a driver, said mobile chassis having an inner side and an outer side, a top, and a bottom, and said frame having an inner and outer side, said outer side of mobile chassis nested within the outer side of the frame; said lead screw engaged to said worm gear, with said worm gear engaged to said worm, and said worm being engaged to said motor, with said lead screw having a top face in contact with the bottom of the mobile chassis; engaging the motor to rotate, wherein rotation of the motor rotates the worm, rotating the lead screw with the rotation of the worm; and extending the lead screw and the mobile chassis, wherein said extending of the lead screw and the mobile chassis increases the volume of the cavity of the speaker system.

23. (canceled)
